(19) United States
(12) Patent Application Publication
(10) Pub. No.: US 2022/0062670 A1
(43) Pub. Date: Mar. 3, 2022

(54) Multiple Layer Mask

(71) Applicant: Melody Maddox, Monroe, GA (US)

(72) Inventor: Melody Maddox, Monroe, GA (US)

(21) Appl. No.: 17/083,640

(22) Filed: Oct. 29, 2020

Related U.S. Application Data
(60) Provisional application No. 63/070,315, filed on Aug. 26, 2020.

(51) Int. Cl. A62B 18/02; B32B 7/09; B32B 7/12; B32B 5/26; A41D 31/14; B32B 7/06; A41D 13/11; A41D 27/08; A62B 18/08; A62B 23/02

(52) U.S. Cl. CPC A62B 18/025; B32B 7/09; B32B 7/12; B32B 5/26; A41D 31/145; B32B 7/06; B32B 2571/00; A41D 27/08; A62B 18/084; A62B 23/025; A41D 2300/32; B32B 2262/0253; B32B 2437/00; A41D 13/1161

(57) ABSTRACT

A multiple layer mask for protection against airborne hazards. An inner layer is made of cloth and an outer layer is made of washable plastic which are permanently or removably attached to each other. A vent filter is disposed within the outer layer. An intermediate layer may be disposed between the inner and outer layers. The layers of the mask help protect against virus droplets or other infectious pathogens from penetrating the mask and assists in reducing the spread of contagious viruses that are transmitted in the air through respiratory droplets. The invention affords civilians, doctors, nurses, service members, and others peace of mind that they are better protected against airborne pathogens.

### CROSS-REFERENCE TO RELATED APPLICATION

The present application claims priority to, and the benefit of, U.S. Provisional Application No. 63/070,315, which was filed on Aug. 26, 2020 and is incorporated herein by reference in its entirety.

### BACKGROUND

The present invention relates generally to an air filtering face mask. More specifically, the invention relates to a protective antibacterial face mask that has two or more layers for enhanced protection from harmful pathogens and other contagions in air. The face mask has multiple layers and ear loops for wearing the face mask. The face mask is vented to allow airflow for a user. The multiple layered face mask is washable for reuse, and can be easily utilized by civilians, doctors, nurses, service members, and others. Accordingly, the present specification makes specific reference to a unique multiple layer face mask. However, it is to be appreciated that aspects of the present invention are also equally amenable to other like applications, devices and methods of manufacture.

By way of background, a pandemic is an epidemic of any disease that has spread across a large region, for instance multiple continents or worldwide, affecting a substantial number of individuals. There have been a number of pandemics such as smallpox, tuberculosis, Plague, Spanish Flu and others. Current pandemics include HIV/AIDS and the Coronavirus disease of 2019 (COVID-19). Such pandemics are caused by exponential spread of virus, bacteria, contagions or pathogens causing the infectious disease.

Various solutions have been proposed for the containment and mitigation of pandemics. For example, certain non-pharmaceutical interventions may be taken to manage the outbreak. In a flu like pandemic such as COVID-19 or those causing respiratory distress, these actions may include personal preventive measures such as hand hygiene, sanitization, wearing face-masks, and self-quarantine. Additionality, community measures aim at social distancing techniques such as closing schools and cancelling mass gatherings, and environmental measures include cleaning and disinfecting of surfaces. However, social distancing and environmental measures such as social distancing is not feasible always.

The World Health Organization (WHO) and other health experts recommend the use of masks for preventing the transmission of COVID-19, and strongly encourage that health workers operating in clinical areas of health facilities, the general public, military service members and others to wear masks when out of home or in an area of probable infection transmission. The widespread use of masks can significantly limit the spread of certain respiratory viral diseases, including COVID-19 and other infectious diseases. The masks can be used either for protection of healthy persons or for source control. The use of face mask helps to decrease the transmission of disease between those who are infected with any virus, bacteria or the like, and those who are not, so as to stop or slow down the rate and extent of the disease.

Various face masks available in the market are designed to protect a user and those in close proximity to the user against contamination due to air-borne bacteria, pathogens, particulates, and the like by minimizing or eliminating the number of air-borne bacteria or pathogens which can be exhaled and then subsequently inhaled by others. Basic cloth face masks provide a relatively comfortable and inexpensive face covering which does not interfere with the actions and visibility of the user. Surgical and medical masks are also available in the market. These masks are utilized by medical professionals to prevent contamination of a patient or their visitors. Medical masks also protect the user's mouth and nose from contacting splashes or sprays of the patient's blood or other body fluids and from other airborne bacteria and pathogens. Additionally, despite their name, the use of medical masks is not limited to medical uses and can also be used by non-medical personnel including the general public. For example, medical masks may be employed by private individuals in times of pandemics and other illness to help protect the individual wearer from exposing others or becoming exposed to an airborne viral disease.

However, existing facemasks typically only include a single layer of material such as cloth or the like, which forms a barrier between environment and the nasal and oral passage of a user. There is evidence to suggest that a single layer mask is not particularly proficient at stopping transmission of harmful air-borne bacteria, pathogens, particulates or the like. Further, without proper protection, the airborne droplets can infiltrate and transmit the virus from one person to another relatively easily and quickly.

Therefore, there exists a long felt need for an improved air filtering face mask that prevents transmission of harmful air-borne bacteria, pathogens, particulates, contagions or the like between an infected person and a user. There also exists a long felt need for an improved face mask that is not a single layer of material and one that provides better protection from infectious diseases. There also exists a long felt need for a face mask that provides a better airflow mechanism. There also exists a long felt need in the art for a face mask that is washable and reusable. Finally, there is a long felt need in the art for an affordable, easy to use and comfortable face mask, that provides airflow for users, and protection against contamination due to air-borne bacteria, pathogens, particulates, and the like.

In this manner, the improved protective mask of the present invention accomplishes all of the forgoing objectives, thereby providing a user with a mask that protects the users from the transmission of virus, air-borne bacteria, pathogens, particulates, and the like, and thereby helps limit virus spread during a pandemic. The improved face mask provides safe airflow for wearers, thereby reducing breathability problems. The present invention exhibits superior virus or other harmful pathogen filtering along with airflow characteristics, and that can be easily worn by a wearer. The improved face mask is washable and reusable. The mask reduces the risk that virus droplets are able to penetrate the mask and assists in reducing the spread of contagious viruses that are transmitted in the air through respiratory droplets. The invention affords civilians, doctors, nurses, service members, and others peace of mind that they are better protected against airborne pathogens.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a multiple layer face mask that exhibits superior virus or other harmful pathogen filtering along with airflow characteristics, and that can be easily worn by a wearer. More specifically, the multiple layer face mask comprises a mask body and a pair of ear loops. The mask body comprises an inner layer and an outer layer permanently attached to the inner layer. The inner layer may be a cloth layer, such as one made from woven and non-woven materials including cotton, natural fibers, natural and synthetic fibers or combinations thereof. The outer layer is made from a washable plastic or synthetic layer or other woven and non-woven materials such as polypropylene. The inner and outer layers cooperate to filter out particles greater than three microns.

The mask body portion is attached to the ear loops for providing a mechanism to secure the multiple layer face mask to the face of the wearer. The multiple layer face mask further comprises a vent filter which provides an airflow for users and thereby reduces any breathability issues faced by the users. The two layers of the face mask may be sewn together along a seam or be heat sealed. The improved face mask is washable and reusable. The double layered face mask ensures COVID-19 virus droplets are less likely to penetrate the mask and assists in reducing the spread of contagious viruses that are transmitted in the air through respiratory droplets.

The mask body has may be configured in an arch shape and includes a fold line which substantially divides the mask in half. When the mask is worn by the wearer, this fold line or crease line, is more or less aligned with an imaginary vertical line passing through the center of the forehead, the nose, and the center of the mouth. The vent filter may be attached to the mask body to allow air flow for users without transmission of any harmful virus, bacteria, air-borne pathogens or the like which leads to spread of diseases. The multiple layer face mask may further comprise a cushion element. The cushion element may be attached to an inner surface of the inner layer around a perimeter of the mask body.

In an additional embodiment, a multiple layer face mask comprises a mask body and a pair of ear loops. The mask body comprises an inner layer and an outer layer removably attached to the inner layer. The inner layer may be a cloth layer, such as one made from woven and non-woven materials including cotton, natural fibers, natural and synthetic fibers or combinations thereof. The outer layer is made from a washable plastic or synthetic layer or other woven and non-woven materials such as polypropylene. The mask body portion is attached to the ear loops for providing a mechanism to secure the multiple layer face mask to the face of the wearer. The inner and outer layers cooperate to filter out particles greater than three microns.

The multiple layer face mask further comprises a vent filter which provides an airflow for users and thereby reduces any breathability issues faced by the users. The two layers of the face mask may be layer is layer on the outer surface of the mask body and includes the vent for air flow. Additionally, the ear loops may be made up of elastic cotton or elastic fiber material and may be adjustable using plastic beads, slidable clasps or other length adjusting mechanism.

The multiple layer face mask may further comprise a cushion element. The cushion element may be attached to an inner surface of the inner layer around a perimeter of the mask body. The mask body may alternatively have a lining on the perimeter, to provide support to the mask structure and a better or more secure fitting for the wearer and to form a seal between the skin and the face mask. The two layers of the face mask can be easily detached to wash the cloth layer, and may be attached again for use, thereby making the multiple layer mask reusable and washable. a foam lined perimeter structure to help distribute pressure of the face mask on the user's face. The cushion element is preferably non-permeable to pathogens, bacteria, viruses, etc. and widens the surface area of the mask perimeter, thereby increasing the surface area and reducing the overall pressure on the user's skin which can lead to skin irritation and discomfort. In differing embodiments of the present invention, the foam perimeter may also include a skin-safe adhesive backing that aids the face mask in forming a better seal against the face area of the user. snapped on or may be attached through a hook and loop type of mechanism, or other fastening devices. The face mask layers can be detachable as and when required.

In an additional embodiment, a multiple layer face mask comprises a mask body and a pair of ear loops. The mask body comprises an inner layer and an outer layer removably attached to the inner layer. The mask body further comprises an intermediate layer disposed between the inner and outer layers. The inner layer may be a cloth layer, such as one made from woven and non-woven materials including cotton, natural fibers, natural and synthetic fibers or combinations thereof. The outer layer is made from a washable plastic or synthetic layer or other woven and non-woven materials such as polypropylene. The mask body portion is attached to the ear loops for providing a mechanism to secure the multiple layer face mask to the face of the wearer. The inner, intermediate, and outer layers cooperate to filter out particles greater than three microns.

The multiple layer face mask further comprises a vent filter which provides an airflow for users and thereby reduces any breathability issues faced by the users. The two layers of the face mask may be layer is layer on the outer surface of the mask body and includes the vent for air flow. Additionally, the ear loops may be made up of elastic cotton or elastic fiber material and may be adjustable using plastic beads, slidable clasps or other length adjusting mechanism. The multiple layer face mask may further comprise a cushion element. The cushion element may be attached to an inner surface of the inner layer around a perimeter of the mask body. The mask body may alternatively have a lining on the perimeter, to provide support to the mask structure and a better or more secure fitting for the wearer and to form a seal between the skin and the face mask.

The two layers of the face mask can be easily detached to wash the cloth layer, and may be attached again for use, thereby making the multiple layer mask reusable and washable. a foam lined perimeter structure to help distribute pressure of the face mask on the user's face. The cushion element is preferably non-permeable to pathogens, bacteria, viruses, etc. and widens the surface area of the mask perimeter, thereby increasing the surface area and reducing the overall pressure on the user's skin which can lead to skin irritation and discomfort. In differing embodiments of the present invention, the foam perimeter may also include a skin-safe adhesive backing that aids the face mask in forming a better seal against the face area of the user. snapped on or may be attached through a hook and loop type of mechanism, or other fastening devices. The face mask layers can be detachable as and when required.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of one embodiment of a multiple layer face mask of the present invention in accordance with the disclosed architecture.

FIG. 2 illustrates an exploded view of the multiple layer face mask of the present invention in accordance with the disclosed architecture.

FIG. 3 illustrates a front view of a user wearing the multiple layer face of the present invention in accordance with the disclosed architecture.

FIG. 4 illustrates a sectional view of an inner layer and an outer layer of a mask body fixedly attached to form the multiple layer face mask of the present invention in accordance with the disclosed architecture.

FIG. 5 illustrates an exploded view of a multiple layer face mask of the present invention in accordance with the disclosed architecture.

FIG. 6 illustrates a sectional view of an inner layer and an outer layer of a mask body removably attached to form the multiple layer face mask of the present invention in accordance with the disclosed architecture.

FIG. 7 illustrates an exploded view of the inner layer and outer layer attaching to form the mask body via a connecting component in accordance with the disclosed architecture.

FIG. 8 illustrates an exploded view of a multiple layer face mask of the present invention in accordance with the disclosed architecture.

### DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

As noted above, there exists a long felt need for an improved air filtering facemask that decreases transmission of harmful air-borne bacteria, pathogens, particulates, contagions or the like between an infected person and a user. There also exists a long felt need for an improved face mask that is not constructed of a single layer of material and provides better protection against infectious diseases. There also exists a long felt need that provides a facemask with better airflow. There also exists a long felt need for a face mask that is washable and reusable. Finally, there is a long felt need for an affordable, easy to use and comfortable face mask, that provides enhanced airflow for users, and protection against contamination due to air-borne bacteria, pathogens, particulates, contagions and the like.

The subject matter disclosed and claimed herein, in one embodiment thereof, comprises a multiple layer face mask that exhibits superior virus or other harmful pathogen filtering along with airflow characteristics, and that can be easily worn by a wearer. More specifically, the multiple layer face mask has a body portion constructed from at least two layers, wherein a first one is an inner cloth layer and the other or second is an outer washable plastic layer. The body portion is attached with ear loops for providing a securing mechanism for the mask. The outer plastic layer includes a vent to provide an enhanced airflow for users and thereby reduces any breathability issues faced by the users. The two layers of the face mask may be sewn together, or snapped on, or may be attached through a hook and loop mechanism, or other fastening mechanism. The face mask layers can be detachable as and when required. The improved face mask is washable and reusable. The double layered face mask reduces the risk that COVID-19 virus droplets are able to penetrate the mask, and assists in reducing the spread of contagious viruses that are transmitted in the air through respiratory droplets. The invention affords civilians, doctors, nurses, service members, and others peace of mind that they are better protected against airborne pathogens.

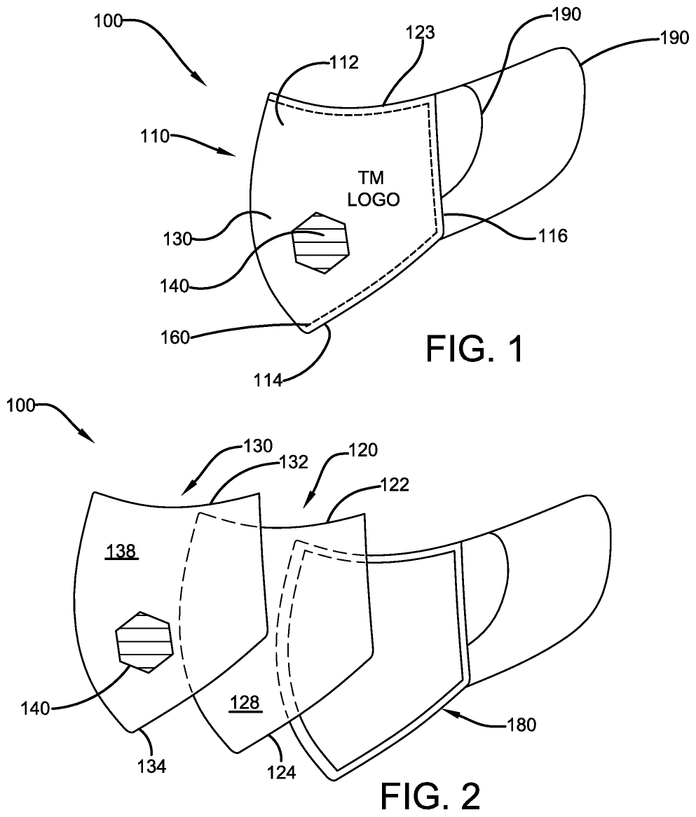

Referring initially to the drawings, FIGS. 1-4 illustrate a front perspective view of a multiple layer face mask 100. The multiple layer face mask 100 comprises a mask body 110, a pair of ear loops 190 and a vent filter 140. The mask body 110 is an arch shaped structure having a top edge 112, a bottom edge 114, and a perimeter 116. The mask body 110 comprises an inner layer 120 and an outer layer 130. The inner layer 120 is permanently attached to the outer layer 130 via a seam 160. The seam 160 may be a stitched or sewn seam, a heat seal, or other permanent adhesive seam.

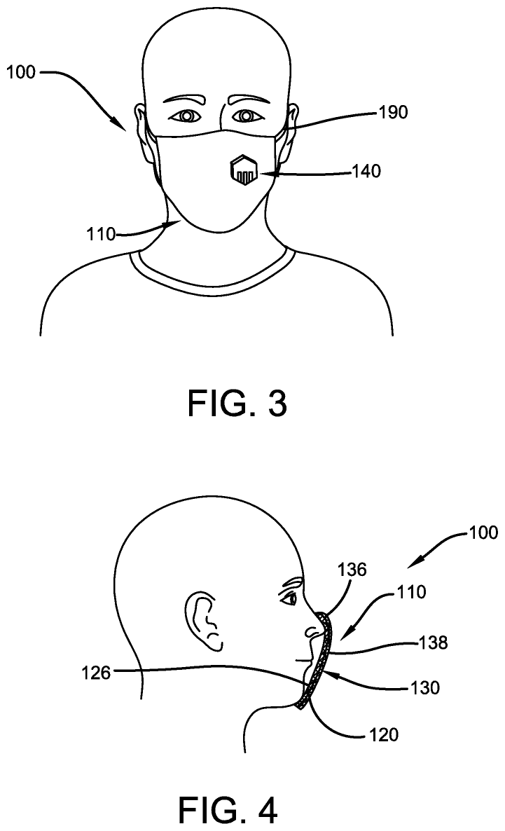

As illustrated in FIGS. 2 and 3, the inner layer 120, which is in contact with the skin of a wearer wearing the multiple layer face mask 100, and is made up of cotton, cloth, natural fiber, synthetic fiber, non-woven fabric or other air filtering material. The inner layer 120 comprises a top 122, a bottom 124, an inner surface 126, and an outer surface 128. The inner layer 120 should ideally be soft and comfortable since it is near the face and could absorb oils and other debris from the face. The filter material may be formed of any known type of filter material so as to filter out or prevent any harmful pathogens, particulate elements, virus, bacteria or the like present in the air, from reaching the wearer thereby helping to protect the wearer from transmission of any diseases and reducing the spread of diseases. The inner surface 126 may be formed of finer fibers, may have a softer and therefore more comfortable surface to lie against the face of the wearer. The outer surface 120 is positioned against the outer layer 130.

The outer layer 130 forming an outer surface of the multiple layer face mask 100 is made up of plastic or other similar or synthetic washable material. The outer layer 130 comprises a top 132, a bottom 134, an inner surface 136, and an outer surface 138. The inner surface 136 is positioned against the outer surface 128 of the inner layer 120. The outer surface 138 forms the outer surface of the mask body 110 can display without limitation, any number of patterns, colors, logos, text, slogans, etc. desired by the wearer, thereby allowing the wearer to easily customize the multiple layered face mask 100. The outer surface 138 may be transparent, translucent or opaque as desired by the wearer. The inner layer 120 and the outer layer 130 are sealed together around the perimeter 116 and the seam 160 is formed around the sealed periphery of the mask body 110 when the inner layer 120 and the outer layer 130 are sewn together.

The vent filter 140 is disposed within and completely penetrates the outer layer 130 of the mask body 110 for airflow and ventilation of the wearer. The vent filter 140 may be positioned on any part of the mask body 110 such as left-side portion or right-side portion. The vent filter 140 allows for a freer passage of air exhaled by the wearer of the mask to outside of the mask 100 and reduces any breathability issues faced by the wearer such as by buildup of carbon dioxide in the interior of the face mask 100.

The pair of ear loops 190 are attached to the mask body 110 near the perimeter 116. The pair of ear loops 190 are formed using an elastic cotton strap or other elastic material and are stitched on the right edge and the left edge of the mask body 110, respectively. The ear loops 190 may be adjustable and the length of the strap of ear loops 190 may be adjusted using plastic beads, buckle or other similar methods.

The shape of the mask body 110 is not limited and can be other shapes such as cup shaped or others, while covering the nasal and oral passage of the wearer. The top 112 of the mask body 110 extends to cover the nose bridge up to cheekbone area and the bottom 114 of the mask body 110 extends to cover the chin portion up to cheeks. The dimensions of the mask body 110 is not limited and can be shaped and sized as needed. A nose bridge may be optionally utilized on the center of the top 112 of the mask body 110 to sit over the nose of the wearer. The nose bridge or nose-clip may be an elongated deformable member that conforms the top 112 of the face mask 100, that holds the mask 100 in place, over the bridge of the wearer's nose. The wearer may adjust the nose-bridge needed through a deformable material, such as an aluminum strip in the nose piece. The mask body 110 may have a fold line which substantially divides the mask body 110 in half, and when the face mask 100 is worn by the wearer, the fold line or crease line, is more or less aligned with an imaginary vertical line passing through the center of the forehead, the nose, and the center of the mouth.

The multiple layer face mask 100 may further comprise a cushion element 180. The cushion element 180 is attachable to the inner surface 126 of the inner layer 120 around the perimeter 116 of the mask body 110. The cushion element 180 is configured to provide a seal between the mask body 110 and the user's face. The cushion element 180 may be a foam structure on the periphery of the mask body 110. The foam-based lining on the periphery is preferably non-permeable to pathogens, bacteria, viruses, contagions, particulate and the like. The cushion element 180 widens the surface area of the mask body 110 periphery and distributes the pressure exerted by the face mask 100 against the face of the wearer when the face mask 100 is worn and thereby reduces the overall pressure on the user's skin which can lead to rashes, skin irritation or other skin related issues. The perimeter 116 may also include a skin-safe adhesive backing that aids the mask body 110 in forming a better seal against the face of the wearer.

The inner layer 120 has a part of filter media of the mask 100 and the outer layer 130 forms a barrier for any air borne pathogens or harmful particles in the air. The use of multiple layers for manufacturing face mask 100 is important for increasing the efficiency of the mask 100 in preventing the transmission of virus, bacteria or the like and thereby protects the wearer from the spread of any air-borne or infectious disease. The inner and outer layers 120 and 130 cooperate to filter out particles greater than three microns.

The manufacturing of the face mask 100 of the present invention, initially provides that the inner layer 120 and the outer layer 130 are cut-out in a similar shape such as an arch shape or a cup shape or others from their respective choice of material, of exactly equal size. The cutting may be performed by a laser, die cutter or other similar devices. A cut-out for the vent filter 140 is provided in the outer layer 130 and the vent filter 140 is attached to the cut-out portion in the outer layer 130 using adhesives, heat or other methods. Alternatively, the vent filter 140 may be detachable and replicable.

The vent filter 140 is then incorporated into the outer layer 130. After completely overlapping the inner layer 120 and the outer layer 130, the two layers 120 and 130 are joined together by sewing using a thread and forming the seam 160. In addition to sewing, the first and second layers may also be secured together by adhesive, heat, fasteners, or combinations thereof The pair of ear loops 190 may be stitched or attached on the left and right edges of the joined layers 120 and 130.

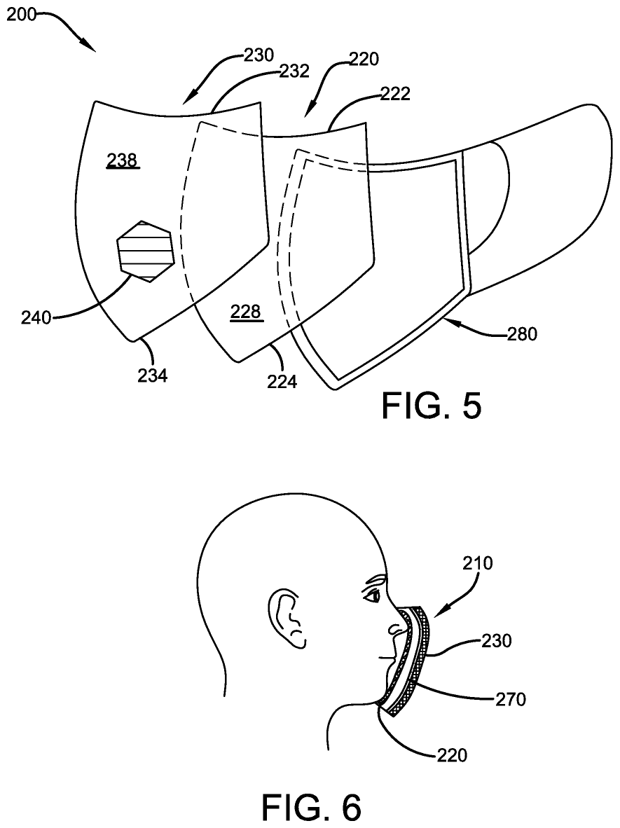

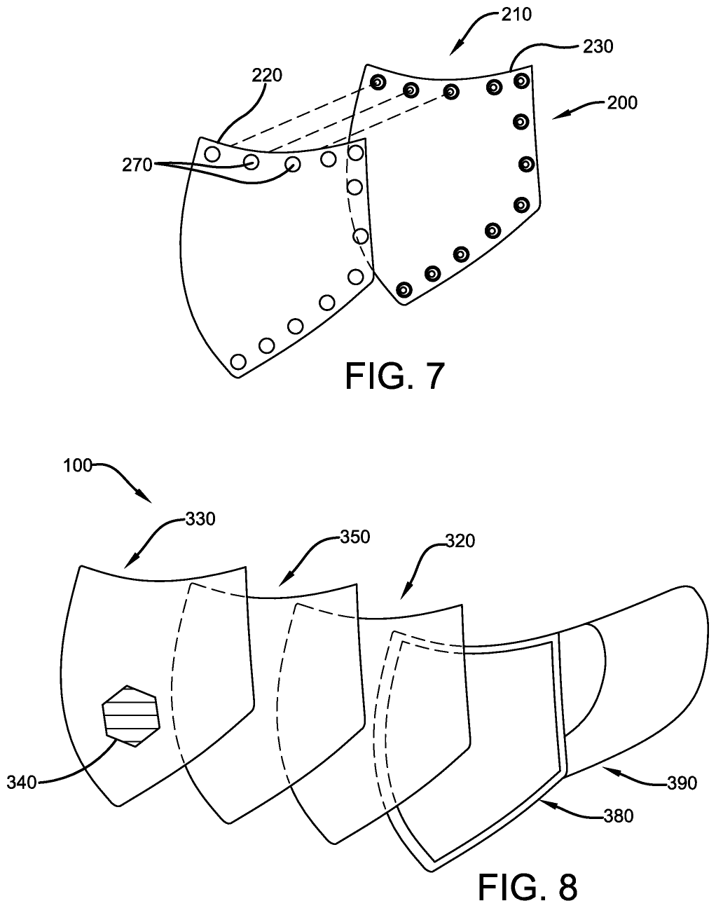

In an additional embodiment as illustrated in FIGS. 5-7, a multiple layer face mask 200 comprises a mask body 210, a pair of ear loops 290, and a vent filter 140. The mask body 210 is an arch shaped structure having a top edge 212, a bottom edge 214, and a perimeter 116. The mask body 210 comprises an inner layer 220 and an outer layer 230. The outer layer 230 is removably attachable to the inner layer 220 via a connecting component 270. The connecting component 270 may be a hook and loop fastening system as illustrated in FIG. 6, or a snap type fastening system as illustrated in FIG. 7. The connecting component 270 allows the user to easily detach the inner and outer layers 220 and 230 for washing or replacement.

The inner layer 220, which is in contact with the skin of a wearer wearing the multiple layer face mask 200, and is made up of cotton, cloth, natural fiber, synthetic fiber, non-woven fabric or other air filtering material. The inner layer 220 comprises a top 222, a bottom 224, an inner surface 226, and an outer surface 228. The inner layer 220 should ideally be soft and comfortable since it is near the face and could absorb oils and other debris from the face. The filter material may be formed of any known type of filter material so as to filter out or prevent any harmful pathogens, particulate elements, virus, bacteria or the like present in the air, from reaching the wearer thereby helping to protect the wearer from transmission of any diseases and reducing the spread of diseases. The inner surface 226 may be formed of finer fibers, may have a softer and therefore more comfortable surface to lie against the face of the wearer. The outer surface 220 is positioned against the outer layer 230.

The outer layer 230 forming an outer surface of the multiple layer face mask 200 is made up of plastic or other similar or synthetic washable material. The outer layer 230 comprises a top 232, a bottom 234, an inner surface 236, and an outer surface 238. The inner surface 236 is positioned against the outer surface 228 of the inner layer 220. The outer surface 238 forms the outer surface of the mask body 210 can display without limitation, any number of patterns, colors, logos, text, slogans, etc. desired by the wearer, thereby allowing the wearer to easily customize the multiple layered face mask 200. The outer surface 238 may be transparent, translucent or opaque as desired by the wearer. The inner and outer layers 220 and 230 cooperate to filter out particles greater than three microns.

The vent filter 240 is disposed within and completely penetrates the outer layer 230 of the mask body 210 for airflow and ventilation of the wearer. The vent filter 240 may be positioned on any part of the mask body 210 such as left-side portion or right-side portion. The vent filter 240 allows for a freer passage of air exhaled by the wearer of the mask to outside of the mask 200 and reduces any breathability issues faced by the wearer such as by buildup of carbon dioxide in the interior of the face mask 200.

The pair of ear loops 290 are attached to the mask body 210 near the perimeter 216. The pair of ear loops 290 are formed using an elastic cotton strap or other elastic material and are stitched on the right edge and the left edge of the mask body 210, respectively. In an embodiment, the ear loops 290 may be adjustable and the length of the strap of ear loops 290 may be adjusted using plastic beads, buckle or other similar methods.

The connecting component 270 may use hooks on the outer surface 128 of the inner layer 220 and corresponding loops on the inner surface 236 of the outer layer 230 or vice versa. As such, the inner and outer layers 220 and 230 are pressed together, and the hooks catch the loops and bind inner and outer layers 220 and 230 together. It is also contemplated that any other type of fasteners can also be used such as buttons, snaps, zippers, etc. for removably attached the inner and outer layers 220 and 230 of the face mask 200 of the present invention. Such fastening mechanisms enable the wearer to quickly and readily attached or detach the inner and outer layers 220 and 230 of the face mask 200. In such scenarios, the ear loops 290 are also attached by means of hook and loop fasteners or may be sewn on the inner layer 220.

The multiple layer face mask 200 may further comprise a cushion element 280. The cushion element 280 is attachable to the inner surface 226 of the inner layer 220 around the perimeter 216 of the mask body 210. The cushion element 280 is configured to provide a seal between the mask body 210 and the user's face. The cushion element 280 may be a foam structure on the periphery of the mask body 210. The foam-based lining on the periphery is preferably non-permeable to pathogens, bacteria, viruses, contagions, particulate and the like. The cushion element 280 widens the surface area of the mask body 210 periphery and distributes the pressure exerted by the face mask 200 against the face of the wearer when the face mask 200 is worn and thereby reduces the overall pressure on the user's skin which can lead to rashes, skin irritation or other skin related issues. The perimeter 216 may also include a skin-safe adhesive backing that aids the mask body 210 in forming a better seal against the face of the wearer.

In an additional embodiment as illustrated in FIG. 8, a multiple layer face mask 300 comprises a mask body 310, a pair of ear loops 390, and a vent filter 340. The mask body 310 is an arch shaped structure having a top edge 312, a bottom edge 314, and a perimeter 316. The mask body 310 comprises an inner layer 320, an intermediate layer 350, and an outer layer 330. The outer layer 330 is removably attachable to the inner layer 320 via a connecting component 370 with the intermediate layer 350 sandwiched between. The connecting component 370 may be a hook and loop fastening system or a snap type fastening system. The connecting component 370 allows the user to easily detach the inner and outer layers 320 and 330 for washing or replacement.

The inner layer 320, which is in contact with the skin of a wearer wearing the multiple layer face mask 300, and is made up of cotton, cloth, natural fiber, synthetic fiber, non-woven fabric or other air filtering material. The inner layer 320 comprises a top 322, a bottom 324, an inner surface 326, and an outer surface 328. The filter material may be formed of any known type of filter material so as to filter out or prevent any harmful pathogens, particulate elements, virus, bacteria or the like present in the air, from reaching the wearer thereby helping to protect the wearer from transmission of any diseases and reducing the spread of diseases. The outer surface 320 is positioned against the outer layer 330.

The outer layer 330 forming an outer surface of the multiple layer face mask 300 is made up of plastic or other similar or synthetic washable material. The outer layer 330 comprises a top 332, a bottom 334, an inner surface 336, and an outer surface 338. The inner surface 336 is positioned against the outer surface 328 of the inner layer 320. The outer surface 338 forms the outer surface of the mask body 310. The intermediate layer 350 may be manufactured from an additional filtering material and may act as an insulator. The inner and outer layers 320 and 330 cooperate to filter out particles greater than three microns.

The vent filter 340 is disposed within and completely penetrates the outer layer 330 of the mask body 310 for airflow and ventilation of the wearer. The vent filter 340 may be positioned on any part of the mask body 310 such as left-side portion or right-side portion. The vent filter 340 allows for a freer passage of air exhaled by the wearer of the mask to outside of the mask 300 and reduces any breathability issues faced by the wearer such as by buildup of carbon dioxide in the interior of the face mask 300.

The pair of ear loops 390 are attached to the mask body 310 near the perimeter 316. The pair of ear loops 390 are formed using an elastic cotton strap or other elastic material and are stitched on the right edge and the left edge of the mask body 310, respectively. In an embodiment, the ear loops 390 may be adjustable and the length of the strap of ear loops 390 may be adjusted using plastic beads, buckle or other similar methods.

The connecting component 370 may use hooks on the outer surface 328 of the inner layer 320 and corresponding loops on the inner surface 336 of the outer layer 330 or vice versa. As such, the inner and outer layers 320 and 330 are pressed together, and the hooks catch the loops and bind inner and outer layers 320 and 330 together. It is also contemplated that any other type of fasteners can also be used such as buttons, snaps, zippers, etc. for removably attached the inner and outer layers 320 and 330 of the face mask 300 of the present invention. Such fastening mechanisms enable the wearer to quickly and readily attached or detach the inner and outer layers 320 and 330 of the face mask 300. In such scenarios, the ear loops 390 are also attached by means of hook and loop fasteners or may be sewn on the inner layer 320.

The multiple layer face mask 300 may further comprise a cushion element 380. The cushion element 380 is attachable to the inner surface 326 of the inner layer 320 around the perimeter 316 of the mask body 310. The cushion element 380 is configured to provide a seal between the mask body 310 and the user's face. The cushion element 380 may be a foam structure on the periphery of the mask body 310. The foam-based lining on the periphery is preferably non-permeable to pathogens, bacteria, viruses, contagions, particulate and the like. The cushion element 380 widens the surface area of the mask body 310 periphery and distributes the pressure exerted by the face mask 300 against the face of the wearer when the face mask 300 is worn and thereby reduces the overall pressure on the user's skin which can lead to rashes, skin irritation or other skin related issues. The perimeter 316 may also include a skin-safe adhesive backing that aids the mask body 310 in forming a better seal against the face of the wearer. The cushion element 380 may retain its shape when bent to better seal against the face.

All of the embodiments 100, 200, and 300 may feature UV resistance and has UPF50+ coating on the layer facing outwards. The face mask 100, 200, and 300 may feature anti-bacterial or silver based coating as well. The face mask 100, 200, and 300 filters oily and non-oily fine particulate pollutants. The mask 100, 200, and 300 effectively filters PM 2.5 pollutants as well. The face mask 100, 200, and 300 is used for the protection of respiratory organs and can effectively filter and purify inhaled abnormal odor, helps to reduce the exposure level of some inhalable microbial particulates (such as virus, anthrax bacillus and tuberculosis bacillus, etc.). Accordingly, the protective face mask 100, 200, and 300 of the present invention helps to prevent the spread of pandemics such as COVID-19 and others, by filtering out material of 3 microns or greater.

Notwithstanding the forgoing, the multiple layer face mask 100, 200, and 300 can be any suitable size, shape, and configuration as is known in the art without affecting the overall concept of the invention, provided that it accomplishes the above stated objectives. One of ordinary skill in the art will appreciate that the shape and size of the face mask 100, 200, and 300 and its various components, as shown in the FIGS. are for illustrative purposes only, and that many other shapes and sizes of the face mask 100, 200, and 300 are well within the scope of the present disclosure. Although dimensions of the two-layer mask 100 and its components (i.e., length, width, and height) are important design parameters for good performance, the face mask 100, 200, and 300 and may be any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multiple layer face mask, comprising;
a mask body comprising an inner layer and an outer layer permanently attached to the inner layer;
a vent filter disposed within the outer layer; and
a pair of ear loops attached to the mask body; and
wherein the inner and outer layers cooperate to filter out particles greater than three microns.

2. The multiple layer face mask of claim 1, wherein the inner layer is attached to the outer layer via a seam around a perimeter of the mask body.

3. The multiple layer face mask of claim 1, wherein inner layer is heat sealed to the outer layer around a perimeter of the mask body.

4. The multiple layer face mask of claim 1, wherein the inner layer is formed from cotton, a natural fiber, a synthetic fiber, or a combination thereof.

5. The multiple layer face mask of claim 1, wherein the outer layer is formed from a washable plastic material.

6. The multiple layer face mask of claim 1, wherein the vent filter completely penetrates the outer layer.

7. The multiple layer face mask of claim 1 further comprising a cushion element attached to an inner surface of the inner layer around a perimeter of the mask body.

8. The multiple layer face mask of claim 7, wherein the cushion element is configured to provide a seal between the mask body and a user's face.

9. A multiple layer face mask comprising:
a mask body comprising an inner layer and an outer layer removably attached to the inner layer;
a vent filter disposed within and completely penetrating the outer layer; and
a pair of ear loops attached to the mask body; and
wherein the inner and outer layers cooperate to filter out particles greater than three microns.

10. The multiple layer face mask of claim 9, wherein the inner layer and the outer layer are manufactured from different materials.

11. The multiple layer face mask of claim 9, wherein the mask body is washable.

12. The multiple layer face mask of claim 9, wherein the inner layer is removably attached to the outer layer via a connecting component.

13. The multiple layer face mask of claim 12, wherein the connecting component is a hook and loop fastening system.

14. The multiple layer face mask of claim 9, wherein the vent filter is detachable from the outer layer.

15. The multiple layer face mask of claim 9 further comprising a cushion element attached to an inner surface of the inner layer around a perimeter of the mask body.

16. The multiple layer face mask of claim 15, wherein the cushion element is configured to adjustably conform the mask body to the user's face.

17. A multiple layer face mask, comprising;
a mask body comprising an inner layer, an outer layer removably attached to the inner layer, and an intermediate layer disposed between the inner and outer layers;
a vent filter disposed within and completely penetrating the outer layer; and
a pair of ear loops attached to the mask body; and
wherein the inner, intermediate, and outer layers cooperate to filter out particles greater than three microns.

18. The multiple layer face mask of claim 17 further comprising a cushion element attached to an inner surface of the inner layer around a perimeter of the mask body.

19. The multiple layer face mask of claim 18, wherein the cushion element is configured to retain its shape when bent.

20. The multiple layer face mask of claim 17, wherein the pair of ear loops are adjustable.
